(19) United States
(12) Patent Application Publication
(10) Pub. No.: US 2005/0143478 A1
(43) Pub. Date: Jun. 30, 2005

(54) Catalyst for preparing polyurethane

(75) Inventors: Mitsuru Sakai, Wakayama-shi (JP); Koei Hosokawa, Wakayama-shi (JP)

Correspondence Address: BIRCH STEWART KOLASCH & BIRCH, PO BOX 747, FALLS CHURCH, VA, 22040-0747, US

(73) Assignee: Kao Corporation

(21) Appl. No.: 11/017,836

(22) Filed: Dec. 22, 2004

(30) Foreign Application Priority Data
Dec. 24, 2003 (JP) 2003-427636

(51) Int. Cl. C08J 9/00

(52) U.S. Cl. 521/50

(57) ABSTRACT

A catalyst for preparing a polyurethane, containing triethylenediamine (component A), and at least one or more members selected from the group consisting of 1,8-diazabicyclo[5.4.0]undecene-7,1,5-diazabicyclo[4.3.0]nonene-5 and salts thereof (component B); a process for preparing a polyurethane, having the step of reacting a polyisocyanate component with a polyol component in the presence of the above-mentioned catalyst for preparing a polyurethane; and a polyurethane prepared by reacting a polyisocyanate component with a polyol component in the presence of the above-mentioned catalyst for preparing a polyurethane. The polyurethane of the present invention is suitably used, for example, for shoe soles for business shoes, sports shoes and the like, particularly for its outer soles.

### FIELD OF THE INVENTION

The present invention relates to a catalyst for preparing a polyurethane. More specifically, the present invention relates to a catalyst for preparing a polyurethane and a process for preparing a polyurethane using the catalyst.

### BACKGROUND OF THE INVENTION

Polyurethane has been prepared by mixing a polyol component with a catalyst and as occasion demands an additive such as a chain extender to give a polyol solution, and injecting the polyol solution and a polyisocyanate component into a mold to react with each other.

Polyurethane has been widely used for shoe soles since polyurethane has advantages such as the polyurethane is excellent in wear resistance and causes less foot fatigue when walking, and that the polyurethane is easier to process for producing a shoe sole than other materials, as compared to a rubber shoe sole and an ethylene-vinyl acetate copolymer (EVA) shoe sole.

“Polyurethane Resin Handbook,” written by Keiji Iwata (Sep. 25, 1987, THE NIKKAN KOGYO SIMBUN, LTD.) discloses that an organotin compound or a tertiary amine compound is used as a catalyst when a polyurethane is prepared. Among them, triethylenediamine has been often used in preparation of polyurethanes since the triethylenediamine has a well-balanced catalytic activity.

However, when a polyurethane is prepared using triethylenediamine, there is a disadvantage that the transparency of the polyurethane is lowered. Therefore, a polyurethane having sufficiently satisfactory transparency has not yet been prepared using the triethylenediamine.

On the other hand, when a polyurethane is prepared using the organotin compound, the organotin compound causes hydrolysis in the polyol solution, so that the transparency and the reacitivity become unstable. Particularly, when the polyurethane is used in molding for a shoe sole, the temperature of the polyol solution should be controlled to 30° to 50° C., so that there arises a disadvantage such that the unstableness in transparency and reactivity tends to be increased.

Also, Japanese Patent Laid-Open No. Sho 62-233102 discloses a process for producing a transparent shoe sole, using triethylenediamine as a catalyst for preparing an urethane. However, this method has a disadvantage that the transparency of the shoe sole obtained is lowered in accordance with the passage of time.

### SUMMARY OF THE INVENTION

The present invention relates to:
(1) a catalyst for preparing a polyurethane, containing triethylenediamine, and at least one or more members selected from the group consisting of 1,8-diazabicyclo[5.4.0]undecene-7,1,5-diazabicyclo[4.3.0]nonene-5 and salts thereof;
(2) a process for preparing a polyurethane, having the step of reacting a polyisocyanate component with a polyol component in the presence of the above-mentioned catalyst for preparing a polyurethane; and
(3) a polyurethane prepared by reacting a polyisocyanate component with a polyol component in the presence of the above-mentioned catalyst for preparing a polyurethane.

### DETAILED DESCRIPTION OF THE INVENTION

The present invention relates to a catalyst which imparts transparency to a polyurethane, a polyurethane having excellent transparency which transparency deteriorates less in accordance with the passage of time, and a process for preparing the polyurethane using the catalyst.

The catalyst for preparing a polyurethane of the present invention can provide a polyurethane having excellent transparency which transparency deteriorates less in accordance with the passage of time. Also, according to the process for preparing a polyurethane of the present invention, there can be prepared a polyurethane having excellent transparency which transparency deteriorates less in accordance with the passage of time.

These and other advantages of the present invention will be apparent from the following description.

In the catalyst for preparing a polyurethane of the present invention, one of the great characteristics resides in that the catalyst contains triethylenediamine (hereinafter referred to as “component A”), and at least one or more members selected from the group consisting of 1,8-diazabicyclo[5.4.0]undecene-7,1,5-diazabicyclo[4.3.0]nonene-5 and salts thereof (hereinafter referred to as “component B”).

The reason why a polyurethane having excellent transparency can be obtained by using the catalyst for preparing a polyurethane of the present invention is not clear. Although not wanting to be limited by theory, it is believed that this is based on the fact that component A is used together with component B which has a function of promoting a resinifying reaction, i.e. the reaction of a polyol with an isocyanate, higher than component A, so that a foaming reaction, for instance, a reaction of water with the isocyanate is suppressed, and both a suitable resinifying reaction and a foaming reaction for exhibiting transparency proceed in good balance during the preparation of a polyurethane.

Component B is at least one or more members selected from the group consisting of 1,8-diazabicyclo[5.4.0]undecene-7,1,5-diazabicyclo[4.3.0]nonene-5 and salts thereof, as mentioned above.

In the case where component B is a salt, the salt includes salts formed from 1,8-diazabicyclo[5.4.0]undecene-7 and an acid, and salts formed from 1,5-diazabicyclo[4.3.0]nonene-5 and an acid. The acids for forming the salts include inorganic acids such as hydrochloric acid, sulfuric acid, nitric acid and phosphoric acid, and organic acids such as formic acid, acetic acid, octylic acid, oleic acid and p-toluenesulfonic acid. Among them, the organic acids are preferable, and formic acid, octylic acid, oleic acid and p-toluenesulfonic acid are more preferable, from the viewpoint of solubility to the polyol solution mentioned later and reactivity. It is preferable that the salt which has been previously neutralized is mixed with the polyol solution.

Among component B, 1,8-diazabicyclo[5.4.0]undecene-7 and 1,5-diazabicyclo[4.3.0]nonene-5 are preferable, and 1,8-diazabicyclo[5.4.0]undecene-7 is more preferable, from the viewpoint of enhancing the transparency of the polyurethane.

The value of the weight ratio of component A to component B (component A/component B) is preferably from 1.5 to 120, more preferably from 2 to 60, even more preferably from 2.5 to 40, even more preferably from 3 to 20, from the viewpoint of enhancing the transparency of the polyurethane.

The catalyst of the present invention contains component A and component B. The total content of component A and component B in the catalyst of the present invention is preferably 80 to 100% by weight, more preferably 90 to 100% by weight of the catalyst, from the viewpoint of enhancing the transparency of the polyurethane.

The above-mentioned catalyst may contain another catalyst, for instance, a tertiary amine, an organometallic catalyst such as an organotin compound and an organolead compound within a range which would not hinder the advantages of the present invention.

The polyurethane of the present invention can be prepared by reacting a polyol component with a polyisocyanate component in the presence of the catalyst for preparing a polyurethane of the present invention.

When a polyurethane is prepared by reacting the polyisocyanate component with the polyol component in the presence of the catalyst for preparing a polyurethane of the present invention, the polyurethane may be slightly foamed due to a slight amount of water existing in air or in the polyol component.

Accordingly, in order to reduce the influence of foaming gas remaining in the mold after the mold is closed by, for instance, mounting an upper lid on the mold, and increase the transparency of the polyurethane, it is preferable that the mold is closed by, for instance, mounting the upper lid after the cream time of the polyurethane to be formed in the mold. Also, since the transparency is enhanced by sufficiently applying pressure to the polyurethane, it is preferable that the mold is closed by, for instance, mounting the upper lid on the mold before the gel time of the polyurethane to be formed in the mold.

From these viewpoints, when a polyurethane is prepared in a mold by reacting a polyisocyanate component with a polyol component in the presence of the catalyst for preparing a polyurethane of the present invention, it is preferable that the mold is closed by, for instance, mounting the upper lid on the mold after the cream time and before the gel time of the polyurethane to be formed in the mold.

The cream time and the gel time are described in “Polyurethane Foam” (K. K. Kobunshi Kankou-kai, published in 1987) written by Yoshio Imai. In the present invention, the cream time and the gel time preferably mean the following period of time, respectively.

The cream time is intended to mean a period of time from the starting time of mixing of a polyisocyanate component with a polyol component to the time when the mixture of the polyisocianate component with the polyol component becomes creamy and slightly opaque, and the liquid surface begins to rise.

The gel time is intended to mean a period of time from the starting time of mixing of a polyisocyanate component with a polyol component to the time when the viscosity of the mixture of the polyisocianate component and the polyol component reaches 50000 mPa·s at 100° C. The viscosity of the mixture is determined by VIBRO VISCOMETER CJV 2000 manufactured by CHICHIBU CEMENT CORPORATION.

The polyol component can be used in the form of a polyol solution by mixing the polyol component with the catalyst of the present invention and, as occasion demands, a chain extender and the like.

The polyol component includes commonly used polyester polyols and polyether polyols, as described in “Polyurethane Resin Handbook,” written by Keiji Iwata, published by THE NIKKAN KOGYO SIMBUN, LTD. on Sep. 25, 1987.

The amount of the catalyst of the present invention is preferably from 0.1 to 3 parts by weight, more preferably from 0.2 to 2.5 parts by weight, even more preferably from 0.3 to 2 parts by weight, based on 100 parts by weight of the polyol component, from the viewpoint of increasing the productivity of polyurethane.

It is preferable that the catalyst is added to the polyol component after pre-dissolving a part or all of the catalyst in water or the chain extender employed, from the viewpoint of homogeneous dispersion.

The chain extender includes aliphatic chain extenders and aromatic chain extenders. The aliphatic chain extender is preferably used from the viewpoint of transparency. Preferred examples of the aliphatic chain extender include 1,4-butanediol.

The amount of the aliphatic chain extender is preferably 0.3 to 20 parts by weight, more preferably 2 to 15 parts by weight, even more preferably 5 to 12 parts by weight, based on 100 parts by weight of the polyol component.

The polyisocyanate component includes, for instance, polyisocyanate prepolymers and the like. The polyisocyanate prepolymer may be obtained by reacting a polyol component with a polyisocyanate monomer in an excess amount of the polyisocyanate monomer while stirring by a conventional method.

Concrete examples of the polyisocyanate monomer include polyisocyanate monomers such as tolylene diisocyanate, m-phenylene diisocyanate, p-phenylene diisocyanate, xylylene diisocyanate, 4,4′-diphenylmethane diisocyanate, hexamethylene diisocyanate, isophorone diisocyanate, polymethylenepolyphenyl diisocyanate, 3,3′-dimethyl-4,4′-biphenylene diisocyanate, 3,3′-dimethyl-4,4′-diphenylmethane diisocyanate, 3,3′-dichloro-4,4′-biphenylene diisocyanate and 1,5-naphthalene diisocyanate; their modified products, for instance, carbodiimide-modified products; and the like. These monomers may be used alone or in admixture of at least two kinds. Among them, 4,4′-diphenylmethane diisocyanate, and a combined use of 4,4′-diphenylmethane diisocyanate and its carbodiimide-modified product are preferable from the viewpoint of obtaining sufficient strength and wear resistance as a shoe sole.

Among the polyisocyanate prepolymers, a polyisocyanate prepolymer obtained by using 4,4′-diphenylmethane diisocyanate or a carbodiimide-modified 4,4′-diphenylmethane diisocyanate is preferable from the viewpoint of securing sufficient strength.

In the polyisocyanate prepolymer obtained by using a carbodiimide-modified 4,4′-diphenylmethane diisocyanate, 4,4′-diphenylmethane diisocyanate may be contained.

When the polyol solution is reacted with the polyisocyanate component, it is desired that the ratio of the polyol solution to the polyisocyanate component is adjusted so that the isocyanate index becomes preferably 70 to 200, more preferably 90 to 180, even more preferably 100 to 170.

The polyurethane of the present invention includes polyurethane elastomers.

The process for preparing the polyurethane elastomer includes, for instance, a process including the steps of mixing the polyol component with the polyisocyanate component and stirring the resulting mixture in a molding machine; and injecting the resulting mixture into a mold, to allow it to react, and the like. More specifically, the process for preparing the polyurethane elastomer includes, for instance, a process including the steps of mixing the polyol component, the catalyst and, as occasion demands, an auxiliary; adjusting the temperature of the resulting polyol solution to a temperature of preferably 30° to 50° C., more preferably 35° to 45° C., using a tank or the like, and adjusting the temperature of the polyisocyanate component to a temperature of preferably 30° to 50° C., more preferably 35° to 45° C. using a tank or the like; thereafter mixing the polyol solution with the polyisocyanate component and stirring the resulting mixture in a molding machine such as an automatic mixing-type injection molding machine; and injecting the resulting mixture into a mold, to allow it to react, and the like. The molding machine includes DESMA (commercially available from Klöckner Desma Schuhmaschinen GmbH, trade name).

The density of the polyurethane thus obtained is preferably 0.9 to 1.3 g/cm³, more preferably 1.0 to 1.3 g/cm³ from the viewpoint of obtaining excellent transparency.

### EXAMPLES

The following examples further describe and demonstrate embodiments of the present invention. The examples are given solely for the purposes of illustration and are not to be construed as limitations of the present invention.

### Example 1 and Comparative Examples 1 and 2

100 parts by weight of a polyester polyol commercially available from Kao Corporation under the trade name of EDDYFORM E-502 (hydroxyl value: 86, molecular weight: 1300) as a polyol component, 5 parts by weight of 1,4-butanediol as a chain extender, and the catalyst in an amount as shown in Table 1, based on 100 parts by weight of the polyester polyol (polyol component), were used. These components were mixed with a labo mixer, to give a polyol solution.

Each of the abbreviations listed in Table 1 means the following:
Cat. TB: Triethylenediamine. Since triethylenediamine is solid at ambient temperature, triethylenediamine was dissolved in 1,4-butanediol (a part of the 1,4-butanediol which was used as the chain extender) so that the weight ratio of triethylenediamine to 1,4-butanediol became 1:2, and the resulting solution was used.
DBU: 1,8-Diazabicyclo[5.4.0]undecene-7 commercially available from SUN-APRO LTD

The amount of the catalyst was adjusted so that the molding time for producing a molded product is 3 minutes.

Next, 160 parts by weight of the polyol solution obtained above was mixed with 100 parts by weight of an organic polyisocyanate commercially available from Kao Corporation under the trade name of EDDYFORM B-1009 using a molding machine (DESMA, commercially available from Klöckner Desma Schuhmaschinen GmbH under the trade name of DESMA 583/6 PSA 95). The resulting mixture was injected into a mold for producing a sheet having a size of 100 mm×300 mm×10 mm (for determination of the physical properties, material: iron), to give a polyurethane molded product in a sheet form.

In the following determination of the physical properties and the surface properties, the temperature of the atmosphere for the tests is at 25° C., unless otherwise specified.

The physical properties and lowering of transparency of the molded products in accordance with the passage of time were determined in accordance with the following methods. The results are show in Table 2.

[Density]

The density of the molded products was determined by dividing the weight of a molded product by its volume (300 cm³).

[Final Physical Properties]

(1) Hardness

The hardness was determined using an Asker C hardness meter.
(2) Tensile Strength

The tensile strength was measured according to the method described in Section 3 of JIS K-6301 (Japan Industry Standard) using a Tensile Testing Machine (Model: AGS-SOOG, tensile rate: 100 mm/min) commercially available from Shimadzu Corporation. As a test piece, a molded product having a No. 2-dumbbell form (thickness: 10 mm) was used.
(3) Transparency Retention Ratio

A molded product was allowed to stand in a thermo-hygrostat (50° C., relative humidity: 80%). The molded product was taken out from the thermo-hygrostat at predetermined intervals, and transmitted light and scattered light of the molded products were determined using a turbidimeter commercially available from Nippon Denshoku Kogyo K. K., under the product number of NDH-1001 DP. The turbidity was determined in accordance with the equation:
[Turbidity (%)]=[Scattered Light/Total Transmitted Light]×100

Smaller vales of turbidity indicate better transparency.

TABLE 1

| Ex. No. and Comp. Ex. Nos. | Ex. 1 | Comp. Ex. 1 | Comp. Ex. 2 |
|---|---|---|---|
| Catalyst | | | |
| Cat. TB (parts by weight) | 0.83 | 3.33 | 0 |
| DBU (parts by weight) | 0.083 | 0 | 0.138 |
| Density (g/cm³) | 1.2 | 1.2 | 1.2 |
| Final Physical Properties | | | |
| Hardness (Asker C) | 80 | 83 | 77 |
| Tensile Strength (MPa) | 17.7 | 18.8 | 14.2 |
| Transparency Retention Ratio (%) | | | |
| First Day | 30.2 | 30.8 | 30.3 |
| 1 day Later | 31.3 | 53.5 | 42.6 |
| 3 days Later | 44.2 | 88.9 | 58.4 |
| 6 days Later | 50.8 | 91.6 | 71.2 |
| 9 days Later | 53.5 | 91.6 | 74.3 |

It can be seen from the results shown in Table 1 that since component A and component B are simultaneously used as a catalyst in Example 1, there is obtained a polyurethane which has excellent transparency and also has excellent transparency retention ratio, and its transparency decreases less in accordance with the passage of time, as compared to Comparative Examples 1 and 2 in which either component A or component B is used alone.

### Examples 2 to 5

100 parts by weight of a polyester polyol commercially available from Kao Corporation under the trade name of EDDYFORM E-502 (hydroxyl value: 86, molecular weight: 1300) as a polyol component, 3 parts by weight of 1,4-butanediol as a chain extender, 1.02 parts by weight of Cat. TB, and 0.14 parts by weight of DBU were mixed with a labo mixer, to give a polyol solution.

Next, 170 parts by weight of the polyol solution obtained above was mixed with 100 parts by weight of an organic polyisocyanate commercially available from Kao Corporation under the trade name of EDDYFORM B-1009 with a molding machine (DESMA, commercially available from Klöckner Desma Schuhmaschinen GmbH under the trade name of DESMA 583/6 PSA 95). The resulting mixture was injected into a mold for producing a sheet having a size of 100 mm×300 mm×10 mm (for determination of the physical properties, material: iron), and the mold was closed within a period of time (hereinafter referred to as period for closing mold) as shown in Table 2, to give a polyurethane molded product in a sheet form.

Transmitted light and scattered light of the molded product were determined with a turbidimeter commercially available from Nippon Denshoku Kogyo K. K., under the product number of NDH-1001 DP), and the turbidity (initial transparency) was determined in accordance with the equation:
[Turbidity (%)]=[Scattered Light/Total Transmitted Light]×100

The results are shown in Table 2.

TABLE 2

| | Ex. 2 | Ex. 3 | Ex. 4 | Ex. 5 |
|---|---|---|---|---|
| Cream Time (sec) | 4-5 | 4-5 | 4-5 | 4-5 |
| Gel Time (sec) | 11 | 11 | 11 | 11 |
| Period for Closing | 6 | 9 | 3 | 14 |
| Mold (sec) | | | | |
| Initial Transparency | 31.6 | 30.5 | 49.2 | 38.7 |

It can be seen from the results shown in Table 2 that since the vales of turbidity of the molded products obtained in Examples 2 and 3 are smaller, the initial transparency of the molded products is more excellent, as compared to the molded products obtained in Examples 4 and 5.

Suitable applications of the polyurethane of the present invention include shoe soles for business shoes, sports shoes and the like. In general, a shoe sole is made of members classified as an outer sole used for sandals, business shoes and the like, a midsole used for sport shoes and the like, and an inner sole inserted internally in the shoe. Among these members of shoe soles, the present invention can be suitably used in outer sole applications due to its advantage that the polyurethane has excellent transparency so that it is possible to provide it with various colors and designs.

The present invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A catalyst for preparing a polyurethane, comprising triethylenediamine (component A), and at least one or more members selected from the group consisting of
1,8-diazabicyclo[5.4.0]undecene-7,1,5-diazabicyclo[4.3.0]nonene-5 and salts thereof (component B).

2. The catalyst according to claim 1, wherein the value of the weight ratio of the component A to the component B (component A/component B) is from 1.5 to 120.

3. A process for preparing a polyurethane, comprising reacting a polyisocyanate component with a polyol component in the presence of the catalyst for preparing a polyurethane of claim 1.

4. The process according to claim 3, wherein the value of the weight ratio of the component A to the component B (component A/component B) is 1.5 to 120.

5. The process according to claim 3, wherein the amount of the catalyst is from 0.1 to 3 parts by weight, based on 100 parts by weight of the polyol component.

6. The process according to claim 3, wherein when a polyurethane is prepared in a mold by reacting the polyisocyanate component and the polyol component in the presence of the catalyst for preparing a polyurethane, the mold is closed after the cream time and before the gel time of the polyurethane to be formed in the mold.

7. The process according to claim 6, wherein the mold is closed after the liquid surface of the mixture of the polyisocyanate component and the polyol component begins to rise, and before the viscosity of the mixture reaches 50000 mPa·s at 100° C.

8. The process according to claim 3, wherein the polyurethane is used for shoe soles.

9. A polyurethane prepared by reacting a polyisocyanate component with a polyol component in the presence of the catalyst for preparing a polyurethane of claim 1.

10. The polyurethane according to claim 9, wherein the value of the weight ratio of the component A to the component B (component A/component B) is from 1.5 to 120.
